(19) United States
(12) Patent Application Publication
(10) Pub. No.: US 2019/0042584 A1
(43) Pub. Date: Feb. 7, 2019

(54) PERFORMING MULTIPLE QUERIES WITHIN A ROBUST VIDEO SEARCH AND RETRIEVAL MECHANISM

(71) Applicant: Carrier Corporation, Farmington, CT (US)

(72) Inventors: ZHEN JIA, Shanghai (CN); HUI FANG, Shanghai (CN); ALAN MATTHEW FINN, Hebron, CT (US)

(21) Appl. No.: 16/073,923

(22) PCT Filed: Jan. 24, 2017
(86) PCT No.: PCT/US17/14648

§ 371 Date: Jul. 30, 2018

Related U.S. Application Data
(60) Provisional application No. 62/293,040, filed on Feb. 9, 2016.

(51) Int. Cl. G06F 17/30; G06K 9/00; G06K 9/62

(52) U.S. Cl. CPC G06F 17/3079; G06K 9/6215; G06K 9/00758; G06F 17/30837

(57) ABSTRACT

The disclosed herein relates to a method, a system, and a computer program product. The method, the system, and the computer program product can include selecting a video segment within a video and extracting a feature set from the video segment. The method, the system, and the computer program product can further include retrieving data information that matches the feature set from a database; determining a degree of similarity between each instance of the data information and the feature set; and presenting a ranked result set based on the degree of similarity.

### BACKGROUND

The disclosure relates generally to performing multiple queries within a robust video search and retrieval mechanism.

In general, video surveillance systems provide high volumes of content to a large scale video database. To get useful information from the large scale video databases, users employ video search and retrieval products. However, contemporary video search and retrieval products are cumbersome mechanisms that fail to provide accurate search results in a timely manner.

For instance, contemporary video search and retrieval products utilize a process called search-by-example. With search-by-example, a singular source (e.g., an image, a single frame of a video, or a designated area within an image or single frame) is identified and utilized to search through a large scale video database. Then, results of the search that are similar to the singular source are presented to the user. The problem is that the results can be inaccurate when a piece of one image or frame is selected as a singular source because search-by-example does not evolve the singular source as its appearance might change with perspective, lighting changes, etc. That is, the singular source utilized in search-by-example only represents one instance of the appearance of an object, while the object may have various appearances due to movement, environmental changes, etc. In turn, video search and retrieval performance will not be robust because all of an object's appearances may not be accurately detected from the large scale video database.

For example, a video might include a person who is walking past a camera, where the person is wearing a t-shirt that is white on the front and black on the back. A singular source might be identified as an image or part of an image where only the back of the t-shirt is visible. Since the singular source does not include the front of the t-shirt, all results that would have been similar to a white t-shirt are not found (e.g., all video of the person walking towards the camera are excluded from the results).

### SUMMARY

According to an embodiment, a method, executed by a processor coupled to a memory, comprises selecting a video segment within a video; extracting a feature set from the video segment; retrieving data information that matches the feature set from a database; determining a degree of similarity between each instance of the data information and the feature set; and presenting a ranked result set based on the degree of similarity.

According to an embodiment or the method embodiment above, the selecting the video segment within the video can comprise receiving an input through a user interface that provides a bounding geometric shape around an object of interest.

According to an embodiment or any of the method embodiments above, the video can comprise a video file in a database or a video stream from a source.

According to an embodiment or any of the method embodiments above, the feature set can comprise a numeric encoding of the video segment.

According to an embodiment or any of the method embodiments above, the method can further comprises tracking the video segment by identifying target segments in consecutive frames of the video and extracting feature sets corresponding to each target segment.

According to an embodiment or any of the method embodiments above, the extracting of the feature set from the video segment can utilize a circular encoding mechanism.

According to an embodiment or any of the method embodiments above, the ranked result set can be presented in a most relevant to a least relevant order according to the degree of similarity.

According to an embodiment, a computer program product comprises a computer readable storage medium having program instructions embodied therewith. The program instructions executable by a processor to cause the processor to perform selecting a video segment within a video; extracting a feature set from the video segment; retrieving data information that matches the feature set from a database; determining a degree of similarity between each instance of the data information and the feature set; and presenting a ranked result set based on the degree of similarity.

According to an embodiment or the computer program product embodiment above, the selecting of the video segment within the video can comprise receiving an input through a user interface that provides a bounding geometric shape around an object of interest.

According to an embodiment or any of the computer program product embodiments above, the video can comprise a video file in a database or a video stream from a source.

According to an embodiment or any of the computer program product embodiments above, the feature set can comprise a numeric encoding of the video segment.

According to an embodiment or any of the computer program product embodiments above, the program instruction can further cause the processor to perform tracking the video segment by identifying target segments in consecutive frames of the video and extracting feature sets corresponding to each target segment.

According to an embodiment or any of the computer program product embodiments above, the extracting of the feature set from the video segment can utilize a circular encoding mechanism.

According to an embodiment or any of the computer program product embodiments above, the ranked result set can be presented in a most relevant to a least relevant order according to the degree of similarity

Additional features and advantages are realized through the techniques of the present disclosure. Other embodiments and aspects of the disclosure are described in detail herein. For a better understanding of the disclosure with the advantages and the features, refer to the description and to the drawings.

### BRIEF DESCRIPTION OF THE SEVERAL VIEWS OF THE DRAWINGS

The subject matter is particularly pointed out and distinctly claimed in the claims at the conclusion of the specification. The forgoing and other features, and advantages of the embodiments herein are apparent from the following detailed description taken in conjunction with the accompanying drawings in which:

FIG. 1 illustrates a query-by-example video search and retrieval process flow of a system according to an embodiment;

FIG. 2 illustrates another query-by-example video search and retrieval process flow of a system according to an embodiment;

FIG. 3 illustrates a query-by-example video search and retrieval process schematic of a system according to an embodiment; and

FIG. 4 illustrates a computing device schematic of a system executing a query-by-example video search and retrieval mechanism according to an embodiment.

### DETAILED DESCRIPTION

In view of the above, embodiments disclosed herein may include a system, method, and/or computer program product (herein the system) that provides efficient retrieval and accurate identification of search results across video databases via a query-by-example video search and retrieval mechanism.

In general, with query-by-example, a selection is input to the system that identifies a video segment from a video and uses this video segment to issue queries that trigger search and retrieval operations from a database. The video segment can include, but is not limited to, video segments for some specific time or location, video segments containing objects of interest, or video segments corresponding to a certain video scene or having some semantic attribute. It is noted that a video segment can also include a single frame, an object within a single frame, a spatial segment (a blob, an object), a temporal segment (a clip), a spatiotemporal video segment, etc. To perform the query-by-example video search and retrieval mechanism, the system executes object tracking, multiple query generation, database retrieval with multiple queries, and retrieval results ranking.

Object tracking includes locating a moving object (or multiple objects) over time in a video file on a database or a video stream from a source (e.g., a camera), such that target objects are associated in consecutive video frames. Multiple query generation includes performing successive information retrieval activities to identify information relevant to the moving object, where each query aligns with one of the target objects. Database retrieval with multiple queries includes obtaining and aggregating information relevant to the target objects from the video file on the database or the video stream in to a result set. Retrieval results ranking includes executing a voting or ranking scheme that determines a degree of similarity between the obtained information and the target objects and presents the result set in a desired order.

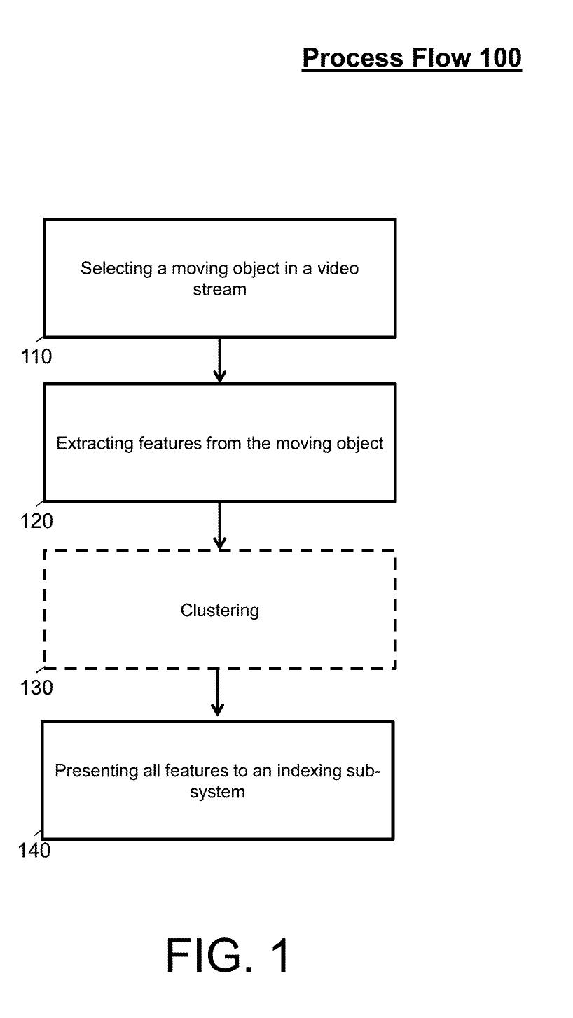

Turning now to FIG. 1, operations of the system will now be described with respect to the process flow 100 according to an embodiment. The process flow begins at block 110, where the system (e.g., directed by a user) selects a moving object in a video stream. In an example operation, the system can employ the process flow 100 in conjunction with a user interface. The user interface can include a selection box where a user can provide an input that selects an object of interest (e.g., with a bounding geometric shape). The user can further indicate that this object of interest should be tracked (e.g., through an interface menu, icon, or button). In an embodiment, if the user only selects a video clip by, for instance, a start time and end time, the system may automatically detect and track moving objects by background subtraction and a Kalman filter or other mechanism.

The moving object can be a video segment desired by the user, who supplies an input to cause the selection. For example, the system can receive an input from a user identifying an image of a person in a frame of a video stream. That person can then be tagged, such as by outlining the image with a box or other geometric shape to denote that this is the person being tracked. The video stream is representative of any live video feed from a camera or other source, or any video file in a database.

At block 120, the system extracts features from the moving object. A feature is a numeric encoding of the data in an image or video. An example of a feature is an intensity gradient and possibly a corner where a black pixel is next to white pixel. Thus, a feature can represent a video or video segment in a smaller amount of information to reduce data bulk, yet still be discriminative.

To extract the feature, the system can utilize a technique, such that the person would be tracked through each frame of the video stream. Examples of techniques include, but are not limited to a Scale Invariant Feature Transform (SIFT), Speed-Up Robust Feature (SURF) algorithm, Affine Scale Invariant Feature Transform (ASIFT), other SIFT variants, a Harris Corner Detector, a Smallest Univalue Segment Assimilating Nucleus (SUSAN) algorithm, a Features from Accelerated Segment Test (FAST) corner detector, a Phase Correlation, a Normalized Cross-Correlation, a Gradient Location Orientation Histogram (GLOH) algorithm, a Binary Robust Independent Elementary Features (BRIEF) algorithm, a Center Surround Extremas (CenSure/STAR) algorithm, an Oriented and Rotated BRIEF (ORB) algorithm, circular coding (CC), etc. For instance, circular encoding is mechanism for describing an image patch or a visual feature using a rotation-invariant binary descriptor. Thus, during extraction, movements of the person over time would be identified so that, as more or less of the person is shown in each frame, a plurality of target objects relative to these varying appearances of the person are procured. In turn, the system will track the changing features of the object and use these changing features to generate multiple queries for results retrieval in the video database.

At block 130, the system can optionally perform a feature set clustering (as denoted by the dash-box). That is, for each tracked person, the feature set extracted from that person in the video segment is clustered using any well-known technique such as k-means clustering, expectation-maximization clustering, density-based clustering, etc. to remove unreliable features (e.g. the cluster size is very small) and to reduce the number of queries to make the search faster.

At block 140, the system presents all features to an indexing sub-system. The system can present all features in the form of queries. The indexing sub-system can be incorporated into or in communication with the system. The indexing sub-system operates to receive the features and return all data that matches these features.

In an embodiment, a voting or ranking scheme can be utilized by the indexing sub-system to determine how similar data of the databases (e.g., the returned data) are to the initial video segment. The results of this determination are then presented in a desired order (e.g., most relevant to least relevant). For example, the returned and ranked results can be displayed as video segments within a presentation section of the user interface.

In another embodiment, all the features of the tracked persons are not presented to the retrieval system at once. Instead, the features of each tracked person are presented to the system to retrieve the K-nearest neighbors for each tracked person. Then for all N tracked persons, there are K×N nearest neighbors for all the submitted queries. The voting or ranking scheme then is applied to all K×N nearest neighbors to present the best retrieval results.

In addition, by utilizing the voting or ranking scheme, all information returned by the database can be presented to the user. For instance, the indexing sub-system can account for oversharing data by pinpointing data approximations and ranking those approximations. That is, because object variations can prevent exact matches between the initially selected moving and returned data, approximate matches are computed and ranked according to how similar the approximations are to the initially selected moving object (e.g., the system determines a degree of similarity between the obtained information and the target objects and presents the result set in a desired order).

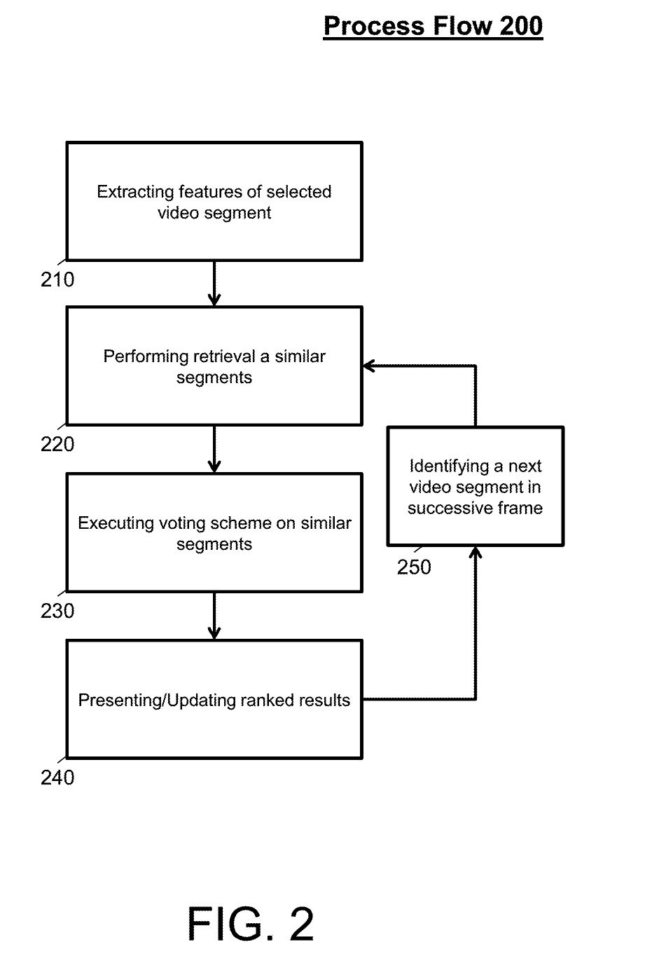

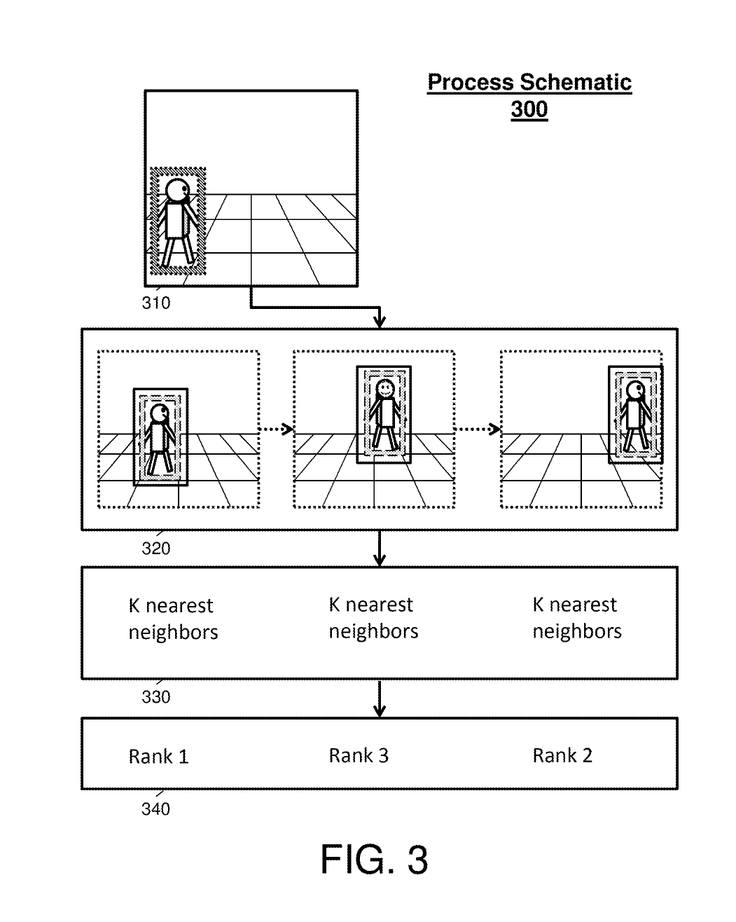

Turning now to FIGS. 2-3, operations of the system will now be described with respect to the process flow 200 and process schematic 300 according to an embodiment. At block 210, the system extracts features of a selected video segment. For example, as shown in the process schematic 300 of FIG. 3, a person is identified as the selected video segment by a user at block 310. The person is identified by the user by placing a dotted-box around the person. The numeric encoding of the selected video segment within the dotted-box is extracted from the video frame to generate a first feature set.

At block 220, the system performs retrieval of similar video segments. For example, the system presents the first feature set to an indexing sub-system in the form of a query. The indexing sub-system utilizes the query to obtain video information that is similar to the first feature set from the databases. This video information can be considered a first result set of similar segments. The first result set is therefore returned to the system by the databases in response to the query.

At block 230, the system executes a voting scheme on the similar segments. That is, the system utilizes the voting scheme to determine how similar each item of first result set of similar segments is to the first feature set.

At block 240, the system presents/updates ranked results. For instance, the first result set is then presented in a desired order based on the determination of block 230 (e.g., most relevant to least relevant). For example, the returned and ranked results can be displayed as video segments within a presentation section of the user interface. In subsequent passes through the loop comprising blocks 220, 230, 240, and 250, updated ranked results are presented at block 240. It should be understood that the results from block 230 may be presented at block 240 as they are produced, or presentation of ranked results at block 240 may be deferred until the iteration through the loop comprising blocks 220, 230, 240, and 250 is complete. After the iteration is complete, the user may employ relevance feedback to further refine the search.

At block 250, the system identifies a next video segment in a successive frame. The selected video segment itself provides a basis for the next video segment and a subsequent feature set. The subsequent feature set of this next video segment is utilized to loop through blocks 220, 230 and 240 of the process flow 200. For example, at block 220, the system presents the subsequent feature set to an indexing sub-system in the form of a query. The indexing sub-system utilizes the query to obtain additional video information that is similar to the subsequent feature set from the databases. This additional video information can be considered a subsequent result set of similar segments (e.g., or can be tagged with an ordinal value j=n−1, where n is an integer corresponding to the query). The subsequent result set is therefore returned to the system by the databases in response to the query.

As shown in FIG. 3 at block 320, the system automatically identifies and tracks the person through consecutive frames. Each frame can be considered as containing a target object comprising the selected moving object. Note that, in this example, the person is moving about the frame (forwards and backward), along with turning (facing away from and towards the camera).

In an embodiment, the system can utilize particle filtering to surround the person with two rectangles, the first of which extract particle samples (see dashed-box) and the second of which identifies a tracked region (see solid-lined box). In turn, while tracking the person, the system automatically extracts features (e.g., the particle samples and tracked region) for use in generating corresponding queries. In this embodiment (and as shown in block 330), metadata is generated for each tracked region may be used as a query and used by the system to find similar video segments, e.g., by finding the k nearest neighbors for each query in the databases.

At block 340, a voting scheme is employed by the system to find an object (such as Object i) with maximum votes or ranking from the returned nearest neighbors. As shown in FIG. 3, the first target frame received a Rank 1, the second target frame received a Rank 3, and the third target frame received a Rank 2. This aligns with the logic that the first target frame is the most similar to the initial selection do to its proximity within the frame and the body position of the person; that the third target frame is the second most similar to the initial selection do to the body position of the person; and that the second target frame is the least similar to the initial selection do to the body position of the person.

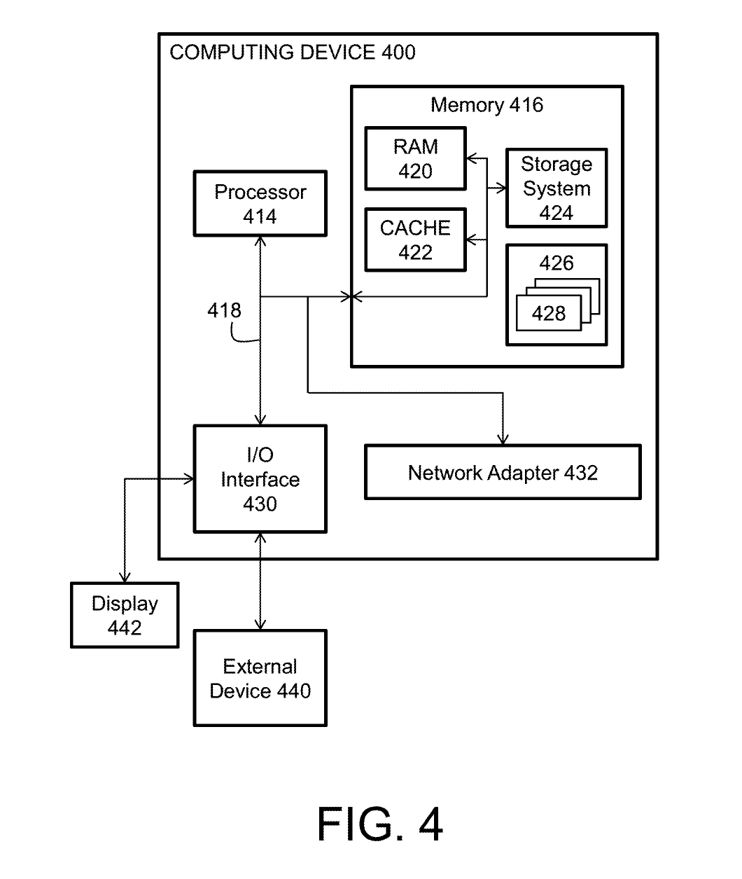

Referring now to FIG. 4, an example schematic of the system is shown as a computing device 400. The computing device 400 is only one example of a suitable computing node and is not intended to suggest any limitation as to the scope of use or operability of embodiments herein described herein (indeed additional or alternative components and/or implementations may be used). That is, the computing device 400 and elements therein may take many different forms and include multiple and/or alternate components and facilities. Further, the computing device 400 may be any and/or employ any number and combination of computing devices and networks utilizing various communication technologies, as described herein. Regardless, the computing device 400 is capable of being implemented and/or performing any of the operations set forth hereinabove.

The computing device 400 can be operational with numerous other general-purpose or special-purpose computing system environments or configurations. Systems and/or computing devices, such as the computing device 400, may employ any of a number of computer operating systems. Examples of computing systems, environments, and/or configurations that may be suitable for use with the computing device 400 include, but are not limited to, personal computer systems, server computer systems, thin clients, thick clients, handheld or laptop devices, multiprocessor systems, microprocessor-based systems, set top boxes, programmable consumer electronics, network PCs, minicomputer systems, computer workstations, servers, desktops, notebooks, network devices, mainframe computer systems, and distributed cloud computing environments that include any of the above systems or devices, and the like.

The computing device 400 may be described in the general context of computer system executable instructions, such as program modules, being executed by a computer system. Generally, program modules may include routines, programs, objects, components, logic, data structures, and so on that perform particular tasks or implement particular abstract data types. The computing device 400 may be practiced in distributed cloud computing environments where tasks are performed by remote processing devices that are linked through a communications network. In a distributed cloud computing environment, program modules may be located in both local and remote computer system storage media including memory storage devices.

As shown in FIG. 4, the computing device 400 is in the form of a general-purpose computing device that is improved upon by the operation and functionality of the computing device 400, its methods, and/or elements thereof. The components of the computing device 400 may include, but are not limited to, one or more processors or processing units (e.g., processor 414), a memory 416, and a bus (or communication channel) 418 which may take the form of a bus, wired or wireless network, or other forms, that couples various system components including to the processor 414 and the system memory 416. The computing device 400 also typically includes a variety of computer system readable media. Such media may be any available media that is accessible by the computing device 400, and it includes both volatile and non-volatile media, removable and non-removable media.

The processor 414 may receive computer readable program instructions from the memory 416 and execute these instructions, thereby performing one or more of the processes defined above. The processor 414 may include any processing hardware, software, or combination of hardware and software utilized by the computing device 414 that carries out the computer readable program instructions by performing arithmetical, logical, and/or input/output operations. Examples of the processor 414 include, but are not limited to an arithmetic logic unit, which performs arithmetic and logical operations; a control unit, which extracts, decodes, and executes instructions from a memory; and an array unit, which utilizes multiple parallel computing elements.

The memory 416 may include a tangible device that retains and stores computer readable program instructions, as provided by the system, for use by the processor 414 of the computing device 400. The memory 416 can include computer system readable media in the form of volatile memory, such as random access memory 420, cache memory 422, and/or the storage system 424.

By way of example only, the storage system 424 can be provided for reading from and writing to a non-removable, non-volatile magnetic media (not shown and typically called a “hard drive”, either mechanical or solid-state). Although not shown, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media can be provided. In such instances, each can be connected to the bus 418 by one or more data media interfaces. As will be further depicted and described below, the memory 416 may include at least one program product having a set (e.g., at least one) of program modules that are configured to carry out the operations of embodiments herein. The storage system 424 (and/or memory 416) may include a database, data repository or other data store and may include various kinds of mechanisms for storing, accessing, and retrieving various kinds of data, including a hierarchical database, a set of files in a file system, an application database in a proprietary format, a relational database management system (RDBMS), etc. The storage system 424 may generally be included within the computing device 400, as illustrated, employing a computer operating system such as one of those mentioned above, and is accessed via a network in any one or more of a variety of manners.

Program/utility 426, having a set (at least one) of program modules 428, may be stored in memory 416 by way of example, and not limitation, as well as an operating system, one or more application programs, other program modules, and program data. Each of the operating system, one or more application programs, other program modules, and program data or some combination thereof, may include an implementation of a networking environment. Program modules 428 generally carry out the operations and/or methodologies of embodiments as described herein (e.g., the process flow 100).

The bus 418 represents one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus.

The computing device 400 may also communicate via an input/output (I/O) interface 430 and/or via a network adapter 432. The I/O interface 430 and/or the network adapter 432 may include a physical and/or virtual mechanism utilized by the computing device 400 to communicate between elements internal and/or external to the computing device 400. For example, the I/O interface 430 may communicate with one or more external devices 440 such as a keyboard and/or a pointing device, a display 442, which may be touch sensitive, etc.; one or more devices that otherwise enable a user to interact with the computing device 400; and/or any devices (e.g., network card, modem, etc.) that enable the computing device 400 to communicate with one or more other computing devices. Further, the computing device 400 can communicate with one or more networks such as a local area network (LAN), a general wide area network (WAN), and/or a public network (e.g., the Internet) via network adapter 432. Thus, I/O interface 430 and/or the network adapter 432 may be configured to receive or send signals or data within or for the computing device 400. As depicted, the I/O interfaces 430 and the network adapter 432 communicates with the other components of the computing device 400 via the bus 418. It should be understood that although not shown, other hardware and/or software components could be used in conjunction with the computing device 400. Examples, include, but are not limited to: microcode, device drivers, redundant processing units, external disk drive arrays, RAID systems, tape drives, and data archival storage systems, etc.

While single items are illustrated for the computing device 400 (and other items) by FIG. 4, these representations are not intended to be limiting and thus, any items may represent a plurality of items. In general, computing devices may include a processor (e.g., a processor 414 of FIG. 4) and a computer readable storage medium (e.g., a memory 416 of FIG. 4), where the processor receives computer readable program instructions, e.g., from the computer readable storage medium, and executes these instructions, thereby performing one or more processes, including one or more of the processes described herein.

In view of the above, the technical effects and benefits include a system that increases with multiple queries a probability of finding all the relevant video segments containing objects of interest. The technical effects and benefits further include a tracking of objects to generate a query that can be visible through a user's GUI, provides a product for more efficient and effective video search and retrieval, and provides improved video management systems with improved search and retrieval capabilities. In turn, the system is more robust to an object's appearance. Thus, the system is necessarily rooted in a computer to overcome the problems arising in contemporary video search and retrieval products.

Computer readable program instructions may be compiled or interpreted from computer programs created using assembler instructions, instruction-set-architecture (ISA) instructions, machine instructions, machine dependent instructions, microcode, firmware instructions, state-setting data, or either source code or object code written in any combination of one or more programming languages, including an object oriented programming language such as C++ or the like, and conventional procedural programming languages, such as the “C” programming language or similar programming languages. The computer readable program instructions may execute entirely on a computing device, partly on the computing device, as a stand-alone software package, partly on a local computing device and partly on a remote computer device or entirely on the remote computer device. In the latter scenario, the remote computer may be connected to the local computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of embodiments herein. Computer readable program instructions described herein may also be downloaded to respective computing/processing devices from a computer readable storage medium or to an external computer or external storage device via a network (e.g., any combination of computing devices and connections that support communication). For example, a network may be the Internet, a local area network, a wide area network and/or a wireless network, comprise copper transmission cables, optical transmission fibers, wireless transmission, routers, firewalls, switches, gateway computers and/or edge servers, and utilize a plurality of communication technologies, such as radio technologies, cellular technologies, etc.

Computer readable storage mediums may be a tangible device that retains and stores instructions for use by an instruction execution device (e.g., a computing device as described above). A computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Thus, the system and method and/or elements thereof may be implemented as computer readable program instructions on one or more computing devices, stored on computer readable storage medium associated therewith. A computer program product may comprise such computer readable program instructions stored on computer readable storage medium for carrying and/or causing a processor to carry out the operations of the system and method. The system, as implemented and/or claimed, improves the functioning of a computer and/or processor itself by enabling an improved search and retrieval capability.

Aspects of embodiments are described herein with reference to flowchart illustrations and/or block diagrams of methods, apparatus (systems), and computer program products. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general-purpose computer, special-purpose computer, or other programmable data processing apparatus to produce a machine, such that the instructions, which execute via the processor of the computer or other programmable data processing apparatus, create means for implementing the operations/acts specified in the flowchart and/or block diagram block or blocks. These computer readable program instructions may also be stored in a computer readable storage medium that can direct a computer, a programmable data processing apparatus, and/or other devices to operate in a particular manner, such that the computer readable storage medium having instructions stored therein comprises an article of manufacture including instructions which implement aspects of the operation/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the operations/acts specified in the flowchart and/or block diagram block or blocks.

The flowchart and block diagrams in the Figures illustrate the architecture, operability, and operation of possible implementations of systems, methods, and computer program products according to various embodiments. In this regard, each block in the flowcharts or block diagrams may represent a module, segment, or portion of instructions, which comprise one or more executable instructions for implementing the specified logical operation(s). In some alternative implementations, the operations noted in the block may occur out of the order noted in the figures. For example, two blocks shown in succession may, in fact, be executed substantially concurrently, or the blocks may sometimes be executed in the reverse order, depending upon the operability involved. It will also be noted that each block of the block diagrams and/or flowchart illustration, and combinations of blocks in the block diagrams and/or flowchart illustration, can be implemented by special purpose hardware-based systems that perform the specified operations or acts or carry out combinations of special purpose hardware and computer instructions.

The descriptions of the various embodiments have been presented for purposes of illustration, but are not intended to be exhaustive or limited to the embodiments disclosed. Many modifications and variations will be apparent to those of ordinary skill in the art without departing from the scope of the described embodiments. The terminology used herein was chosen to best explain the principles of the embodiments, the practical application or technical improvement over technologies found in the marketplace, or to enable others of ordinary skill in the art to understand the embodiments disclosed herein.

The terminology used herein is for the purpose of describing particular embodiments only and is not intended to be limiting. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one more other features, integers, steps, operations, element components, and/or groups thereof.

The flow diagrams depicted herein are just one example. There may be many variations to this diagram or the steps (or operations) described therein without departing from the disclosure. For instance, the steps may be performed in a differing order or steps may be added, deleted or modified. All of these variations are considered a part of the claims.

While embodiments have been described, it will be understood that those skilled in the art, both now and in the future, may make various improvements and enhancements which fall within the scope of the claims which follow. These claims should be construed to maintain the proper protection for at least one of the embodiments described.

1. A method, executed by a processor coupled to a memory, comprising:
selecting a video segment within a video;
extracting a feature set from the video segment;
retrieving data information that matches the feature set from a database;
determining a degree of similarity between each instance of the data information and the feature set; and
presenting a ranked result set based on the degree of similarity.

2. The method of claim 1, wherein the selecting the video segment within the video comprises receiving an input through a user interface that provides a bounding geometric shape around an object of interest.

3. The method of claim 1, wherein the video comprises a video file in a database or a video stream from a source.

4. The method of claim 1, wherein the feature set comprises a numeric encoding of the video segment.

5. The method of claim 1, further comprising:
tracking the video segment by identifying target segments in consecutive frames of the video and extracting feature sets corresponding to each target segment.

6. The method of claim 1, wherein the extracting of the feature set from the video segment utilizes a circular encoding mechanism.

7. The method of claim 1, wherein the ranked result set is presented in a most relevant to a least relevant order according to the degree of similarity.

8. A computer program product, the computer program product comprising a computer readable storage medium having program instructions embodied therewith, the program instructions executable by a processor to cause the processor to perform:
selecting a video segment within a video;
extracting a feature set from the video segment;
retrieving data information that matches the feature set from a database;
determining a degree of similarity between each instance of the data information and the feature set; and
presenting a ranked result set based on the degree of similarity.

9. The computer program product of claim 8, wherein the selecting of the video segment within the video comprises receiving an input through a user interface that provides a bounding geometric shape around an object of interest.

10. The computer program product of claim 8, wherein the video comprises a video file in a database or a video stream from a source.

11. The computer program product of claim 8, wherein the feature set comprises a numeric encoding of the video segment.

12. The computer program product of claim 8, the program instructions executable by the processor cause the processor to perform:
tracking the video segment by identifying target segments in consecutive frames of the video and extracting feature sets corresponding to each target segment.

13. The computer program product of claim 8, wherein the extracting of the feature set from the video segment utilizes a circular encoding mechanism.

14. The computer program product of claim 8, wherein the ranked result set is presented in a most relevant to a least relevant order according to the degree of similarity.
